(19) United States
(12) Patent Application Publication
(10) Pub. No.: US 2007/0027842 A1
(43) Pub. Date: Feb. 1, 2007

(54) Information-paging delivery

(75) Inventor: Courtney C. Lambert, Cedar Park, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/191,215

(22) Filed: Jul. 27, 2005

(51) Int. Cl. G06F 17/30

(52) U.S. Cl. 707/3

(57) ABSTRACT

A method and apparatus for obtaining, storing and accessing information using a wireless communication device is disclosed. A request is sent from a wireless communication device to a information agent, typically a human operator or an Interactive Voice Response (IVR) system. The information agent formulates a search for the requested information and sends the search result to memory associated with the wireless communication device. Memory is provided at the information agent and in local storage such as a Subscriber Identity Module (SIM) in the wireless communication device. The search result can then be accessed at the wireless communication device. Information can be obtained by a search of a proprietary database or by using a search engine to find information over the Internet. The user can be given options concerning types and formats of requested information, as well as options to for using the requested information at the wireless communication device.

### BACKGROUND OF THE INVENTION

1. Field of the Invention

The present invention relates to the field of mobile information retrieval and storage. In particular, the present invention relates to providing options for storing and retrieving information in a wireless communication device.

2. Description of the Related Art

Various means are available to aid telephone users who have insufficient information to complete a call. Such users may not know a phone number, location or other information regarding an intended recipient. Typically, when a caller wants to contact a person or organization, but does not know the telephone number for that person or organization, the caller dials directory assistance, often by dialing ‘411’. Upon calling directory assistance, the caller is typically queried by a directory assistance operator, live or automated, for a name and location for the person or organization which the caller would like to reach. Upon completion of an automated recitation of the requested number to the caller, directory assistance calls are optionally transferred directly to the requested number requested by the caller. This current directory assistance format optionally dials the number but requires the caller to write down or to commit the number to memory in case the call does not go through, or in case a second telephone number is requested. If the caller forgets the number, he must call directory assistance again. Often, it is difficult to write information down or to program a contact into an address book.

Interactive Voice Response, or IVR, systems (hereinafter IVRS) are commonly found operating such services as telephone banking, order placement, caller identification, and airline ticket booking, among others. An IVR is an automated computer-based system that enables a person, typically a telephone caller, to select an option from a help menu. Generally the system plays pre-recorded voice prompts to make selections. In response to a series of prompts, the caller presses a number on a telephone keypad, or speaks simple answers such as “yes”, “no”, to select an options offered by the help menu. Some IVR systems use natural language speech processing to interpret and answer a caller's spoken inquiry. IVR systems are generally provided at the front end of call centers (i.e., a customer service center) in order to obtain information up front. An IVR is typically used to identify what service the caller desires or needs, to extract numeric identifying information such as account numbers, and to provide preliminary answers to simple questions such as account balances or allow pre-recorded informational messages to be heard by the caller. IVRs can provide the ability to verbalize complex and dynamic information, such as an e-mail, news report or weather information, using Text-To-Speech (TTS) translation. TTS provides computer-generated speech. Actual human voices are often used as a basis to create simulated speech in tiny fragments that are reconstituted and played to a caller as an intelligible informational response message.

Recent advances in cellular technology have expanded the range of possibilities available to cell phone users. For example, the reduced size of storage devices, such as hard drives and flash memory, as well as the increased capacity of these storage devices, enables a new functionality for small devices such as cellular phones. For example, current cellular phones can operate a video screen display with camera capabilities and have the ability to store not only phone numbers, but also music files, pictures, etc. Thus there is a need to use these increased abilities in the area of mobile information retrieval and storage.

### SUMMARY OF THE INVENTION

The present invention discloses a method and apparatus for accessing and storing information, such as directory assistance information using a mobile wireless communication device, such as a cellular phone. A request for information is sent from the wireless communication device to a recipient. A recipient may be an information agent such as an Interactive Voice Recorder (IVR), a human operator, a web interface, or a server. The information agent or recipient obtains the request from a user at the wireless communication device, formulates a search, and obtains the requested information based on user input. Requested information can be obtained through a variety of search methods, such as by searching a proprietary database or by using a search engine to find information over the Internet. The recipient obtains the information and sends it to the user's wireless communication device where it is stored in a local device, such as a Subscriber Identity Module (SIM) in the user's wireless communication device. The requested information can then be accessed at the wireless communication device. Requested information received at the SIM can alternatively be stored in a contact list at the wireless communication device to be retrieved at a later time. A search performed by the information agent can be stored on a server associated with the information agent and identified with a unique identifier. The identifier is sent to the SIM for use in re-accessing the search information from the mobile communication device. Retrieving the information from the wireless device obviates the need for initiating a second inquiry call to directory assistance. The user can be given options to select between different types of requested information and also to choose between different formats to receive requested information. The user can also be given options to store the requested information at the wireless communication device so as to retrieve the information at a later time by referring to the SIM of the wireless communication device. The present invention may also auto-populate a search application, etc., with the search results.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 illustrates an exemplary embodiment of the present invention; and

FIG. 2 illustrates a flowchart of functions performed in one aspect of the present invention.

### DETAILED DESCRIPTION OF THE INVENTION

In view of the above, the present invention through one or more of its various aspects and/or embodiments is presented to provide one or more advantages, such as those noted below.

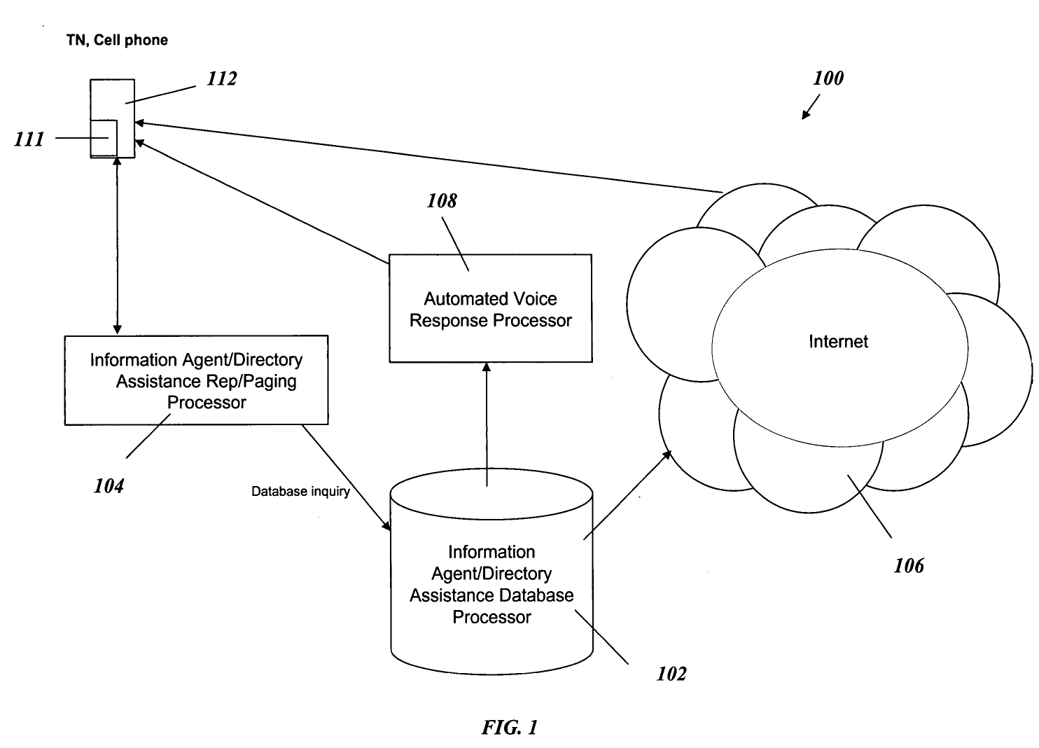

FIG. 1 illustrates an exemplary embodiment 100 of the present invention. The present invention comprises a information agent/recipient 104, such as a directory assistance server or associated representative or an Interactive Voice Response (IVR), in communication with an enabled wireless communication device 112 and a database 102 including the internet 106 which contains searchable and retrievable information. The database 102 also contains a storage space for user searches and search results with are uniquely identified and associated with the user. The unique identifiers are sent to the user 112 along with selected search results for storage on the user SIM card. Thus, the user has access to distributed storage divided between the database and the SIM card 111. The enabled wireless communication device can be a cellular phone, but can also be a personal digital assistant (PDA), a Blackberry, a text pager, or any other suitably web-enabled device. The housing or storage retention of the information can take multiple forms, such as a disk or other storage medium. In an exemplary embodiment, the recipient 104 is a server processor configured to operate an Interactive Voice Response (IVR) system. The IVR runs a programmed sequence of coded steps designed to obtain a set of search terms from a caller from the wireless communication device 112 and then to enter the search terms to formulate and construct a search into the database 102. Alternatively, the recipient 104 can be a human operator (directory assistance representative), a web interface, or a process operating on a server.

Database 102 can be any database or series of linked data bases which refer to each other. The data base may be a proprietary database and can include but is not limited to typically requested information, such as name and telephone number of a person, business, or organization. The database 102 can also refer to a variety of sources accessible via the Internet, such as through a web search engine (i.e., Yahoo) or through an Internet site containing telephone numbers (i.e., www.yellowpages.com, etc.).

An Automated Voice Response processor 108 delivers an audio message from the database to the wireless communication device by enunciating the telephone number to the caller using, for example, using a Text-To-Speech (TTS) device. Paging Application processor 104 returns requested information to the wireless communication device. The caller ID or IP address of the wireless communication device is captured by the recipient 104 at the beginning of the call, thereby enabling the paging application to return data to the correct wireless communication device upon completion of the call. The requested information can include but is not limited to a requested name and telephone number, related web pages, related hyperlinks, etc. The IVR provides the caller with a variety of options for receiving information, which can include selecting the amount of information to receive at the wireless communication device, selecting the type of information, and selecting the format for requested information. For instance, a user could press “1” to receive just an audible playback of a requested number, or could press “2” to receive an audible response plus a text format response of the requested phone number, etc. The requested information can be sent in a variety of formats, including as a web page (HTML format), as a video file (i.e. MPEG format), as an audio file (i.e. mp3 format), as a text file, etc. A text file can be in formatted text, unformatted text, or alphanumeric text. The caller can select the type of information and delivery format of the requested information via the IVR.

The present invention delivers a page and the search result comprising requested information to the wireless device upon completion of the request for information. Additionally, the requested information can be delivered in a format that enables the caller's SIM card to store the data directly to a contact log and/or an address book of the cell phone. The IVR or SIM card processor enables the user to select search, delivery and storage options which can be stored in the data base or on the SIM card which can be used for future reference. Thus future searches can be carried out in accordance with the stored search, delivery and storage options. In another embodiment of the present invention, requested information can be sent directly to a different location, such as to a different telephone number, a fax machine, a personal computer, an IP address, or an email address, etc. The user is given the option of selecting what type or level of search results to be sent to the mobile device such as the SIM card. For example, a user may select to receive only the top N results (e.g., top 3 or 4 results) or select on certain types of information associated with the top N Search results. A user may select also from search results types, including but not limited to results such as phone numbers, locations, web pages, videos, URLs, etc. The entire search, including those search results not selected by the user for delivery to the mobile device are stored in the data base under a unique identifier associated with the user and the particular search. The unique identifier can be sent to the mobile communication device and stored there locally, i.e., in the SIM card. The unique identifier can be retrieved by the user from the SIM card and automatically retransmitted to the information agent for access to the search results without entering another query or call to the information agent.

When the search result comprising at least some of the requested information is sent to the wireless communication device, the requested information is received and store in local storage, such as a SIM card associated with the wireless communication device 112. The SIM card offers options to the caller pertaining to storage, access and use of the requested information. The SIM card typically includes a microprocessor and 8 kilobytes or more of memory. The SIM card microprocessor is configured to store and retrieve search results and search identifiers for searches stored in the information agent database. For example, the requested information can be stored on the wireless communication device so as to be retrieved at a later time. As another example, the SIM card can offer the caller an option to directly save a telephone number, map, web page, video file, audio file, or text file to a contact list in a storage area of the cell phone. An auto-redial option can enable the caller to send a signal back to the recipient (e.g. the directory assistance operator) to redial the number. Additionally, requested information can be auto-populated into a search query at the wireless communication device. This search initiated at the wireless communication device can search a proprietary database to receive information tailored to the specifications of the wireless communication device or to an Internet search, such as through the Yahoo search engine, etc.

The present invention provides multiple delivery options, such as returning information to a different location requested by the user; providing an option to apply a charge for a service; using an automated application that requires no additional input from directory assistance (unless the automated application returns requested information to a different location than is captured with caller IP address or Caller ID); reading data directly from the SIM card; and inputting requested information into a local address book stored on the SIM card.

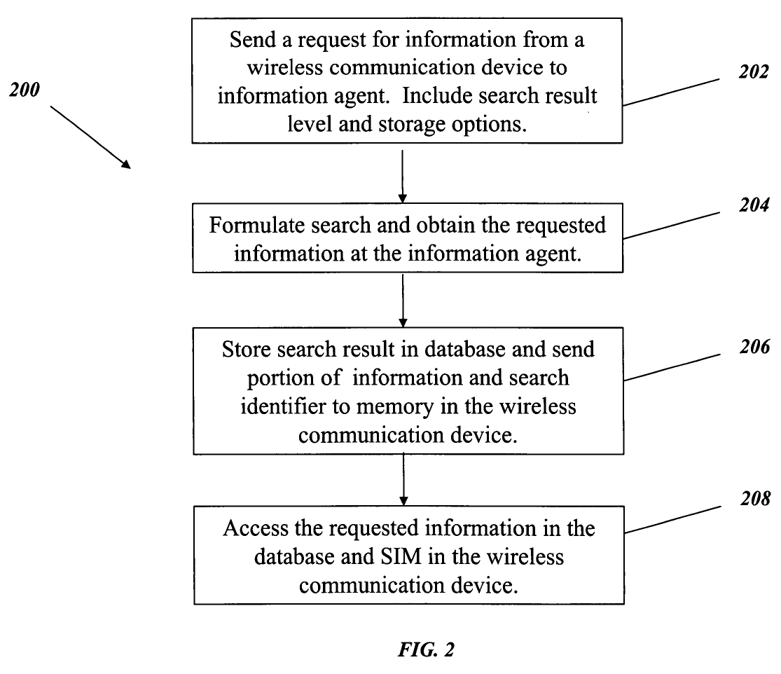

FIG. 2 illustrates a flowchart 200 of one aspect of the present invention. In Box 202, a request for information is sent from the wireless communication device 112 to the information agent recipient 104 server. In an exemplary embodiment, the wireless communication device communicates information to an IVR performing a programmed sequence of steps to capture search terms for a database query. For example, a caller searching for lodging while driving along a highway could call directory assistance and ask for “lodging” or “Motel 6”. The caller's mobile location can be identified by triangulating the caller cell phone location between cell phone towers or by determining the nearest cell phone tower.

In Box 204, the requested information is obtained at the recipient. In an exemplary embodiment of the invention, data is obtained by performing a search on an Internet site. For example, data for “Motel 6” can be obtained through the “Yahoo” search engine. Alternatively, a phone number for the nearest “Motel 6” can be requested at an appropriate URL address, such as “www.yellowpages.com,” for example. Also, information can be obtained from a proprietary database. Requested information can be organized according to various parameters, such as location, price, availability, etc. A user is given an option to format or select how to receive search results such as level, discussed above, and parameters to report, such as results by parameters such as price, proximity or availability. Where a monetary transaction might be expected to result from the subsequent phone call, a page for performing such transactions (i.e. a reservation web page) can be sent with the appropriate information. For example, when a caller asks for “Motel 6” reservations, a reservations web page might include room rates and availability. As another example, when a caller asks for information on a baseball game, a reservations web page might include game time, seat locations, etc. The IVR may parse the reservation page and conduct a verbal reservation session between the user and an IVR or live agent for the hotel front desk or the ticket concessionaire for the ball game. IVR sessions (IVR options/queries and user response/selections) can be stored in the database or SIM card as well for access for return sessions to the same vendor. For example, a second call to the same hotel or ticket concessionaire IVR can be directed by the IVR responses from the prior session. The responses can read back to the user and overridden as necessary for selections that have changed.

In Box 206, requested information is sent to a SIM associated with the wireless communication device. Options for receiving the search result and requested information can be specified by the caller. Such options include, for example, selecting an alternate location to receive the information, such as another cell phone, an email address, or fax machine, etc., selecting the category and amount of information to return, selecting the search information, etc. In Box 208, the user accesses the requested information from the SIM of the wireless communication device. Typically, the SIM receives the page with the requested information and offers the user an option for what to do with the requested information. As one example, maps, audio, video, web page, phone number and address information can be stored in a personal address book associated with the wireless communication device. Alternatively, the requested information can be perused immediately via streaming the audio or video or playback from storage.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivelents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for accessing information using a wireless communication device, comprising:
sending a request for information from the wireless communication device to an information agent;
formulating a search for the information;
obtaining a search result from a data base;
sending the search result to the wireless communication device;
storing the search result in a memory associated with the wireless communication device; and
accessing the search stored in the memory associated with the wireless communication device.

2. The method of claim 1, wherein the memory associated with the wireless communication device comprises memory distributed between the wireless communication device and the database.

3. The method of claim 1, wherein the request further comprises an indication of a level of search results to be sent to the wireless communication device.

4. The method of claim 1, wherein sending the requested information further comprises selecting an option for receiving the search result in a Subscriber Identity Module (SIM) associated with the wireless communication device.

5. The method of claim 1, wherein storing the search results further comprises storing the requested information in a contact list in the memory associated with the wireless communication device.

6. The method of claim 1, wherein the search result further comprises at least one of the set consisting of maps, audio, video, web pages, and text.

7. The method of claim 1, wherein the search result further comprises an identifier for locating the search result in the data base.

8. The method of claim 7, wherein the request further comprises the identifier.

9. A computer readable medium containing instructions that when executed by a computer perform a method for accessing information using a wireless communication device, comprising:
sending a request for information from the wireless communication device to an information agent;
formulating a search for the information;
obtaining a search result from a data base;
sending the search result to the wireless communication device;
storing the search result in a memory associated with the wireless communication device; and
accessing the search stored in the memory associated with the wireless communication device.

10. The medium of claim 9, wherein in the method, the memory associated with the wireless communication device comprises memory distributed between the wireless communication device and the information agent.

11. The medium of claim 9, wherein in the method, the request further comprises an indication of a level of search results to be sent to the wireless communication device.

12. The medium of claim 9, wherein in the method, sending the requested information further comprises selecting an option for receiving the search result in a Subscriber Identity Module (SIM) associated with the wireless communication device.

13. The medium of claim 9, wherein in the method, storing the search results further comprises storing the requested information in a contact list in the memory associated with the wireless communication device.

14. The med of claim 9, wherein in the method, the search result further comprises at least one of the set consisting of maps, audio, video, web pages, and text.

15. The medium of claim 9, wherein in the method, the search result further comprises an identifier for locating the search result in the data base.

16. The medium of claim 15, wherein in the method, the request further comprises the identifier.

17. An apparatus for accessing information using a wireless communication device, comprising:
a server in communication with the wireless communication device, the server configured to receive a request for information from the wireless communication device, formulate a search for the information, and obtain a search result;
a database in communication with the server for performing the search; and
a paging application in communication with the wireless communication device that sends the search result to memory associated with the wireless communication device.

18. The apparatus of claim 17, wherein the memory associated with the wireless communication device comprises memory distributed between the wireless communication device and the server.

19. The apparatus of claim 17, wherein the server is further configures to receive and process an indication of a level of search results to be sent to the wireless communication device.

20. The method of claim 17, wherein storing the search results further comprises storing the search result in memory associated with the wireless communication device.
